(19) United States
(12) Patent Application Publication
(10) Pub. No.: US 2022/0056736 A1
(43) Pub. Date: Feb. 24, 2022

(54) DEAD-LOCKING CONTROL MECHANISM FOR DOOR LOCK

(71) Applicant: Dezhao XIANG, GUANGDONG (CN)

(72) Inventor: Dezhao XIANG, GUANGDONG (CN)

(21) Appl. No.: 17/000,382

(22) Filed: Aug. 24, 2020

(51) Int. Cl. E05B 63/06; E05B 63/16; E05B 13/00; E05B 59/00

(52) U.S. Cl. CPC E05B 63/06; E05B 59/00; E05B 13/004; E05B 63/16

(57) ABSTRACT

The present invention relates to the field of a dead-locking control technology of a door lock, and discloses a dead-locking control mechanism, including: a latch, fixed on a to-be-locked object and configured to cooperate with an external spindle assembly-set and a door frame, a bolt of the latch moving towards an exterior of the latch to extend or retract; a spindle assembly-set, one end of which is detachably linked with and fixedly going through the latch and is configured to drive the bolt to move towards the exterior of the latch to extend or retract, and the other end may include a detachably fixed and connected object to drive operation of the spindle for using; and a dead-locking control assembly-set, configured to control the spindle assembly-set to stop continuous movement, arranged at one end of a driving part of the spindle assembly-set and driven by an external force.

### BACKGROUND OF THE INVENTION

The present invention relates to the technical field of lock, and in particular, to a dead-locking control mechanism for a door lock.

As the name implies, the door lock is a device for locking the door so as to prevent others from opening the door. There are many types of door locks, and the requirements on the door locks are different in various occasions.

Nowadays the dead-locking device is not controlled the bolt of the lock, but adding a separate locking-knob with a separate bolt, this increases the cost and on the other hand it also increases the volume and area of the door lock.

To solve the above problem, the present application provides a dead-locking control mechanism for a door lock.

### BRIEF SUMMARY OF THE INVENTION

(I) Invention Objectives

To solve the technical problems in the background art, the present invention provides a dead-locking control mechanism for a door lock. Stopping continuous movement of the spindle assembly-set is controlled by the dead-locking control assembly-set, thereby controlling the bolt of the linked latch to extend and retract to replace an existing dead-locking knob.

(II) Technical Solution

To solve the above problem, the present invention provides a dead-locking control mechanism for a door lock.

a latch: the latch is fixed on a to-be-locked object and is configured to cooperate with an external spindle assembly-set and a door frame, a bolt locking the to-be-locked object after moving in a direction proximal to the bore;

a spindle assembly-set: one end of the spindle assembly-set is detachably linked with and fixedly going through the latch and is configured to drive the bolt to move in a forward and backward direction of the bore of the strike, and the other end of the spindle assembly-set may include a detachably fixed and connected object to drive operation of the spindle for using; and

a dead-locking control assembly-set: the dead-locking control assembly-set is configured to control the spindle assembly-set to stop continuous movement,

the dead-locking control assembly-set is arranged at one end of the driving part of the spindle assembly-set, and the dead-locking button is driven by an external force so as to enable the spindle assembly-set to be connected to and go distally from a fixing assembly-set to block and unblock stopping continuous movement of the spindle assembly-set, and

the dead-locking control assembly-set is arranged on the fixing assembly-set, and the dead-locking button is driven by an external force so as to enable the fixing assembly-set to be connected to and go distally from the fixing assembly-set to block and unblock stopping continuous movement of the spindle assembly-set.

Preferably, a structure of the dead-locking control assembly-set may be any one of a button plug type structure, a button pop-up type structure, a lever type structure, a plug-pin type structure, a chain type structure, a stop opening type structure, a thimble type structure, a gear type structure and a magnetic valve type structure.

Preferably, a shape of the dead-locking button may be any one of a square shape, a round shape, a conical shape, a trapezoidal shape, a rod shape, a spherical shape, a needle shape, a triangular shape and a column shape.

Preferably, a driving mode of the dead-locking control mechanism may be any one of a push-button type, a sliding type, a bouncing type, a prizing type, a pushing type, a pulling type, a rotating type, a toggling type and a tooth shifting type.

Preferably, the spindle of the spindle assembly-set may be used individually or one end of the spindle may be detachably and fixedly connected to the spindle driving part; one part of the spindle driving part passes through the fixing assembly-set and is fixedly connected to the spindle; and the spindle driving part is arranged on one side distal from the latch.

Preferably, the other end of the spindle of the spindle assembly-set passes through the latch and is in linked connection with the bolt, thereby controlling the bolt to extend and retract.

Preferably, the fixing assembly-set may be an object fixedly mounted on the door and may also be an externally fixedly connected object of the latch.

Preferably, the fixing assembly-set may block and unblock stopping continuous movement of the spindle assembly-set by driving the dead-locking button to be in stop connection with and go distally from a stop socket.

Preferably, the dead-locking control assembly-set consists of a clamp part , a spring and a stop part, wherein the clamp part is clamped in a rotary knob; the rotary knob is circumferentially provided with a sliding opening; the stop part is slidably arranged in the rotary knob, one end of the stop part extends into the fixing assembly-set and is in stop connection with a stop socket of the fixing assembly-set, and a protruded portion of the stop part extends into the sliding opening of the spindle driving part and is slidably connected to the sliding opening; and one end of the spring is fixedly connected to the stop part, and the other end of the spring extends into the clamp part and slides together with the stop part.

Preferably, the fixing assembly-set is provided with a stop socket, and the stop socket is in stop connection with a stop part.

The above technical solution of the present invention has the following beneficial technical effects:

the dead-locking control assembly-set is configured to stop continuous movement of the spindle assembly-set so as to control a deadbolt not to be opened or closed any longer to achieve the aim of keeping the door unlocked or locked; meanwhile, the production cost and the volume of the door lock are reduced, and the single deadbolt is more reasonable.

### BRIEF DESCRIPTION OF THE DRAWINGS

FIG. 1 is a schematic structural diagram of a dead-locking control mechanism for a door lock according to the present invention;

FIG. 2 is a schematic diagram of an internal structure of a rotary knob in a dead-locking control mechanism for a door lock according to the present invention; and

FIG. 3 is a schematic diagram of a side structure of a fixing assembly-set in a dead-locking control mechanism for a door lock according to the present invention.

Reference numerals:1.latch (1.1) latch house; (1.2) bolt; 2 spindle assembly-set; (2.1) spindle; (2.2) spindle driving part; 3 dead-locking control assembly-set; (3.3) enable force part; 3.2 spring; (3.1) clamp part; 4 fixing assembly-set; (4.1) fixing part; (4.2) stop socket.

### DETAILED DESCRIPTION OF THE INVENTION

For clearer descriptions of the objectives, technical solutions, and advantages of the present invention clearer, the present invention is further described hereinafter in detail with reference to the specific embodiments and the accompanying drawings. It should be understood that the descriptions are merely exemplary, but are not intended to limit the scope of the present invention. In addition, in the following description, descriptions of conventional structures and technologies are omitted to avoid unnecessarily confusing the concepts of the present invention.

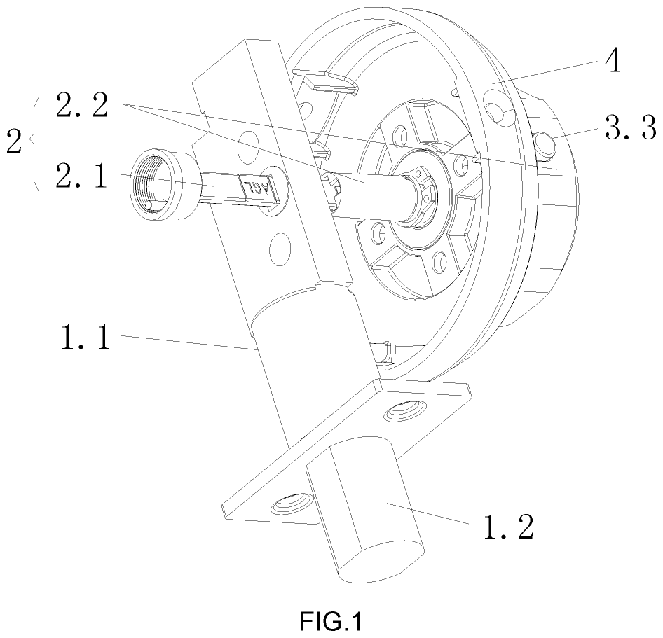

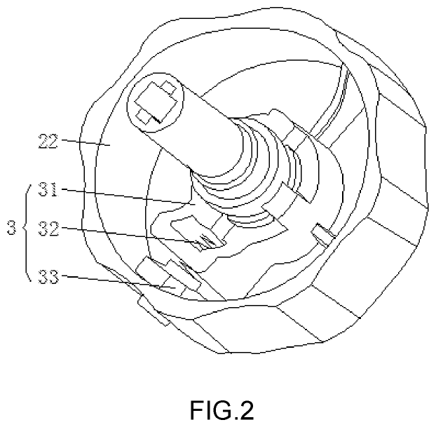

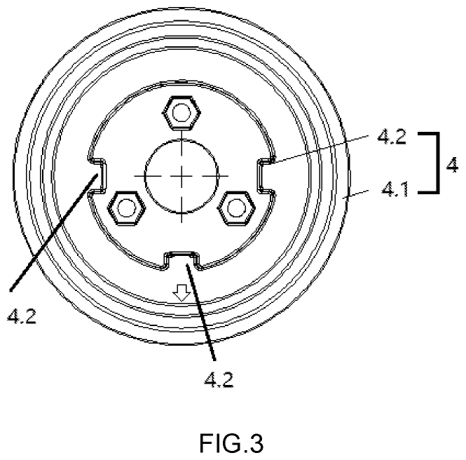

Referring to FIG. 1 to FIG. 3, a dead-locking control mechanism for a door lock includes:

a latch (1): the latch (1) is fixed on a to-be-locked object and is configured to cooperate with an external bore, a bolt (1.2) locking the to-be-locked object after moving in a direction proximal to the bore;

a spindle assembly-set (2): one end of the spindle assembly-set (2)is detachably linked with and fixedly going through the latch (1) and is configured to drive the bolt (1.2)to move in a forward and backward direction of the bore, and the other end of the spindle assembly-set (2) may include a detachably fixed and connected object (2.2)to drive operation of the spindle for using; and

a dead-locking control assembly-set (3): the dead-locking control assembly-set (3) is configured to control the spindle assembly-set to stop continuous movement,

the dead-locking control assembly-set (3) is arranged at one end of the driving part of the spindle assembly-set, and the dead-locking button (3.3) is driven by an external force so as to enable the spindle assembly-set(2) to be connected to and go distally from a fixing assembly-set (4) to block and unblock stopping continuous movement of the spindle assembly-set (2) and

the dead-locking control assembly-set (3) is arranged on the fixing assembly-set (4), and the dead-locking button (3.3) is driven by an external force so as to enable the spindle assembly-set (2) to be connected to and go distally from the fixing assembly-set (4) to block and unblock stopping continuous movement of the spindle assembly-set (2).

In an optional embodiment, a structure of the dead-locking control assembly-set (3)may be any one of a button plug type structure, a button pop-up type structure, a lever type structure, a plug-pin type structure, a chain type structure, a stop opening type structure, a thimble type structure, a gear type structure and a magnetic valve type structure.

In an optional embodiment, a shape of the dead-locking button (3.3) may be any one of a square shape, a round shape, a conical shape, a trapezoidal shape, a rod shape, a spherical shape, a needle shape, a triangular shape and a column shape.

In an optional embodiment, a driving mode of the dead-locking control mechanism 3 may be any one of a push-button type, a sliding type, a bouncing type, a prizing type, a pushing type, a pulling type, a rotating type, a toggling type and a tooth shifting type.

In an optional embodiment, the spindle (2.1) of the spindle assembly-set 2 may be used individually, or one end of the spindle (2.1) may be detachably and fixedly connected to the spindle driving part (2.2); one part of the spindle driving part (2.2) passes through the fixing assembly-set (4) and is fixedly connected to the spindle (2.1); and the spindle driving part (2.2) is arranged on one side distal from the latch (1.1).

In an optional embodiment, the other end of the spindle (2.1) of the spindle assembly-set 2 passes through the latch (1.1) and is in linked connection with the bolt (1.2), thereby controlling the bolt (1.2) to extend and retract.

In an optional embodiment, the fixing assembly-set (4) may be an object fixedly mounted on the door and may also be an externally fixedly connected object of the latch.

In an optional embodiment, the fixing assembly-set (4) may block and unblock stopping continuous movement of the spindle assembly-set 2 by driving the dead-locking button (3.3) to be in stop connection with and go distally from a stop socket (4.2).

In an optional embodiment, the dead-locking control assembly-set (3) consists of a clamp part (3.1), a spring 3.2 and a stop part (3.3), wherein the clamp part (3.1) is clamped in a rotary knob (2.2); the rotary knob (2.2) is circumferentially provided with a sliding opening; the stop part (3.3) is slidably arranged in the rotary knob (2.2), one end of the stop part (3.3) extends into the fixing assembly-set (4) and is in stop connection with a stop socket (4.2) of the fixing assembly-set, and a protruded portion of the stop part (3.3) extends into the sliding opening of the spindle driving part (2.2) and is slidably connected to the sliding opening; and one end of the spring 3.2 is fixedly connected to the stop part (3.3), and the other end of the spring 3.2 extends into the clamp part (3.1) and slides together with the stop part (3.3).

In an optional embodiment, the fixing assembly-set (4) is provided with a stop socket (4.2), and the stop socket (4.2) is in stop connection with a stop part (3.3).

According to the present invention, the stop part (3.3) moves into the fixing assembly-set (4) to stop continuous movement of the spindle (2.1) so as to control the bolt not to be opened or closed any longer to achieve the aim of keeping the door unlocked or locked; meanwhile, the production cost and the volume of the door lock are reduced.

It should be noted that, in this specification, relationship terms such as first and second are only used to distinguish an entity or operation from another entity or operation, but do not necessarily require or imply that there is any actual relationship or order between these entities or operations. Furthermore, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device.

Although the embodiments of the present invention have been illustrated and described, it should be understood that those of ordinary skill in the art may make various changes, modifications, replacements and variations to the above embodiments without departing from the principle and spirit of the present invention, and the scope of the present invention is limited by the appended claims and their legal equivalents.

What is claimed is:

1. A dead-locking control mechanism for a door lock, comprising a latch (1): the latch (1) is fixed on a to-be-locked object and is configured to cooperate with an external spindle assembly-set and a door frame, a bolt (1.2)being driven by a spindle (2.1) to move towards an exterior of the latch (1) to extend or retract;
a spindle assembly-set (2): one end of the spindle assembly-set (2) is detachably linked with and fixedly going through the latch (1) and is configured to drive the bolt (1.2)to move towards the exterior of the latch (1) to extend or retract, and the other end of the spindle assembly-set (2) may include a detachably fixed and connected spindle driving part (2.2)for using; and
a dead-locking control assembly-set (3): the dead-locking control assembly-set (3) is configured to control the spindle assembly-set to stop continuous movement, the dead-locking control assembly-set (3) is arranged at one end of the driving part of the spindle assembly-set, and the dead-locking button (3.3) is driven by an external force so as to enable the spindle assembly-set (2) to be connected to and go distally from a fixing assembly-set (4) to block and unblock stopping continuous movement of the spindle assembly-set (2), and the dead-locking control assembly-set (3) is arranged on the fixing assembly-set (4), and the dead-locking button (3.3) is driven by an external force so as to enable the fixing assembly-set (4) to be connected to and go distally from the spindle assembly-set (2) to block and unblock stopping continuous movement of the spindle assembly-set (2).

2. The dead-locking control mechanism for the door lock according to claim 1, wherein a structure of the dead-locking control assembly-set (3) may be any one of a button plug type structure, a button pop-up type structure, a lever type structure, a plug-pin type structure, a chain type structure, a stop opening type structure, a thimble type structure, a gear type structure and a magnetic valve type structure.

3. The dead-locking control mechanism for the door lock according to claim 1, wherein a shape of the dead-locking button (3.3) may be any one of a square shape, a round shape, a conical shape, a trapezoidal shape, a rod shape, a spherical shape, a needle shape, a triangular shape and a column shape.

4. The dead-locking control mechanism for the door lock according to claim 1, wherein a driving mode of the dead-locking control mechanism (3) may be any one of a push-button type, a sliding type, a bouncing type, a prizing type, a pushing type, a pulling type, a rotating type, a toggling type and a tooth shifting type.

5. The dead-locking control mechanism for the door lock according to claim 1, wherein the spindle (2.1) of the spindle assembly-set (2) may be used individually, or one end of the spindle (2.1) may be detachably and fixedly connected to the spindle driving part (2.2); one part of the spindle driving part (2.2)passes through the fixing assembly-set (4) and is fixedly connected to the spindle (2.1); and the spindle driving part (2.2)is arranged on one side distal from the latch (1.1).

6. The dead-locking control mechanism for the door lock according to claim 1, wherein the other end of the spindle (2.1) of the spindle assembly-set (2) passes through the latch (1.1) and is in linked connection with the bolt (1.2), thereby controlling the bolt (1.2)to extend and retract.

7. The dead-locking control mechanism for the door lock according to claim 1, wherein the fixing assembly-set (4) may be an object fixedly mounted on the door and may also be an externally fixedly connected object of the latch.

8. The dead-locking control mechanism for the door lock according to claim 1, wherein the fixing assembly-set (4) may block and unblock stopping continuous movement of the spindle assembly-set (2) by driving the dead-locking button (3.3) to be in stopping connection with and go distally from a stop socket (4.2).

9. The dead-locking control mechanism for the door lock according to claim 2, wherein the dead-locking control assembly-set (3) consists of a clamp part (3.1), a spring (3.2) and a stop part (3.3), wherein the clamp part (3.1) is clamped in a rotary knob (2.2); the rotary knob (2.2)is circumferentially provided with a sliding opening;
the stop part (3.3) is slidably arranged in the rotary knob (2.2), one end of the stop part (3.3) extends into the fixing assembly-set (4) and is in stop connection with a stop socket (4.2) of the fixing assembly-set, and a protruded portion of the stop part (3.3) extends into the sliding opening of the spindle driving part (2.2)and is slidably connected to the sliding opening; and one end of the spring (3.2) is fixedly connected to the stop part (3.3), and the other end of the spring (3.2) extends into the clamp part (3.1) and slides together with the stop part (3.3).

10. The dead-locking control mechanism for the door lock according to claim 2, wherein the fixing assembly-set (4) is provided with a stop socket (4.2), and the stop socket (4.2) is in stop connection with a stop part (3.3).
